(19) United States
(12) Patent Application Publication
(10) Pub. No.: US 2017/0210389 A1
(43) Pub. Date: Jul. 27, 2017

(54) VEHICLE SENSING SYSTEM WITH AT LEAST TWO SENSORS

(71) Applicant: GKN Driveline North America, Inc., Auburn Hills, MI (US)

(72) Inventor: Rory M. Johnson, Grand Blanc, MI (US)

(21) Appl. No.: 15/003,851

(22) Filed: Jan. 22, 2016

(51) Int. Cl. B60W 40/12

(52) U.S. Cl. CPC B60W 40/12; B60W 2400/00; B60W 2520/10

(57) ABSTRACT

A sensing system for a vehicle includes an electrical sensing circuit that has a first sensor and a second sensor. The sensing circuit is configured to provide a composite output signal that includes data from both the first sensor and second sensor.

### TECHNICAL FIELD

The present disclosure relates generally to a vehicle sensing system that provides signal data from at least two sensors.

### BACKGROUND

Vehicle electronic control modules (ECMs) can communicate vehicle sensor data to one another via a number of interfaces. For example, a communication bus may couple two or more ECMs, and each ECM may transmit addressed packets of sensor data onto the bus which can travel the bus allowing another ECM to identify the packet having its address. Another example of an ECM-to-ECM interface is a cable harness having connectors at opposing ends. For example, two ECMs may be coupled to one another via the cable harness connectors. The harness may have a plurality of discrete wires connected to each of the connectors for transmitting different types of sensor data. However, both communication buses and cable harnesses require relatively large spatial requirements. In implementations where spatial constraints are relatively small, these interfaces may not be feasible. Thus, there is a need for a smaller interface that is capable of transmitting signal data from multiple sensors.

### SUMMARY

In at least some implementations, a sensing system for a vehicle includes an electrical sensing circuit that has a first sensor and a second sensor. The sensing circuit is configured to provide a composite output signal that includes data from both the first sensor and second sensor.

In other implementations, a sensing system for a vehicle includes an electrical sensing circuit that includes a speed circuit having a speed sensor and a temperature circuit having a temperature sensor. The sensing circuit is configured to provide a composite output signal that includes superimposed data received from the speed and temperature circuits.

### BRIEF DESCRIPTION OF THE DRAWINGS

The following detailed description of preferred embodiments and best mode will be set forth with reference to the accompanying drawings, in which:

FIG. 1 is a schematic diagram of a sensing system for a vehicle drive train assembly having a sensing system with an electronic control unit (ECU) and a sensing circuit;

FIG. 2 is a schematic diagram of the sensing circuit of FIG. 1, the sensing circuit configured to sense a rotational speed of a vehicle component and a temperature of a vehicle component;

FIG. 3 is a block diagram illustrating subcomponents of the sensing circuit of FIG. 1;

FIG. 4 illustrates one embodiment of a circuit diagram of the sensing circuit of FIG. 1;

FIGS. 5-6 show illustrative electrical signal outputs of the sensing circuit associated with the circuit diagram of FIG. 4;

FIG. 7 is a block diagram illustrating another embodiment of subcomponents of the sensing circuit of FIG. 1;

FIG. 8 illustrates a circuit diagram of another embodiment of the sensing circuit of FIG. 1; and

FIGS. 9-10 show illustrative electrical signal outputs of the sensing circuit associated with the circuit diagram of FIG. 8.

### DETAILED DESCRIPTION

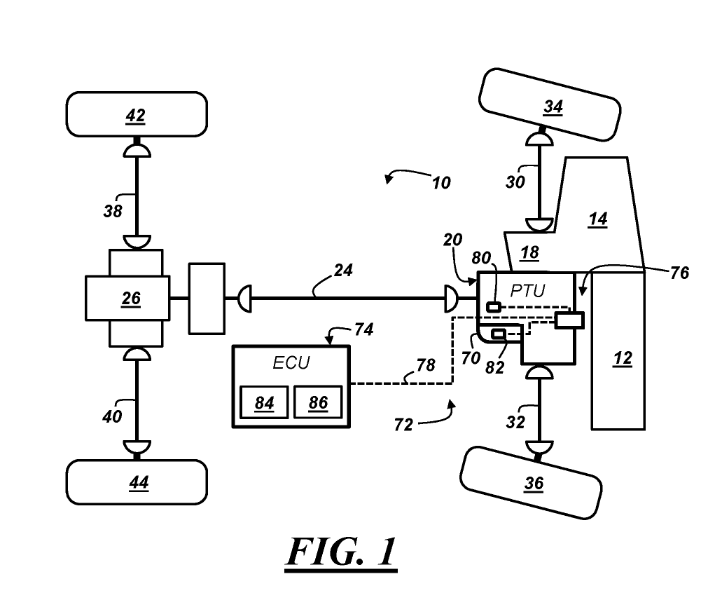

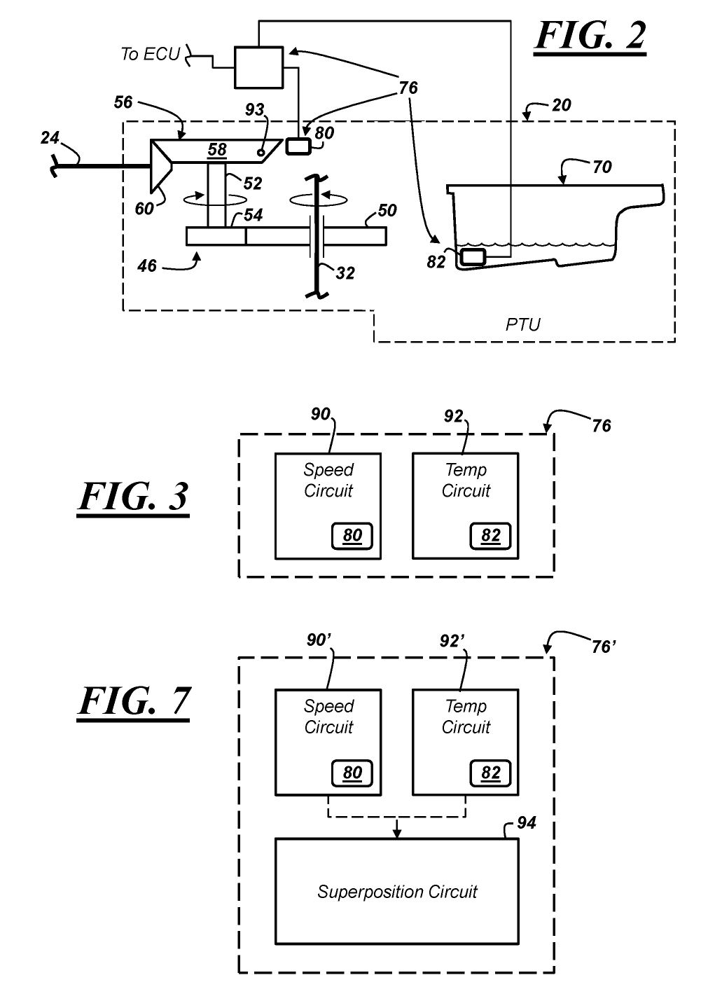

Referring in more detail to the drawings, FIG. 1 illustrates a schematic diagram of a drive train assembly 10 for an all-wheel drive (AWD) vehicle. The assembly 10 includes an engine 12, a transmission 14 coupled to the engine 12, a front differential assembly 18 coupled to the transmission 14, a power transfer unit (PTU) 20 coupled to both the front differential assembly 18 and a proximal end of a propshaft 24, and a rear differential assembly 26 coupled to a distal end of the propshaft 24. Front drive shafts 30, 32 couple respectively the front differential assembly 18 to front wheels 34, 36; similarly, rear drive shafts 38, 40 couple respectively the rear differential assembly 26 to rear wheels 42, 44. In AWD vehicles, the PTU 20 selectively may transfer torque to the rear wheels 42, 44 via the propshaft 24 (e.g., automatically or in response to a user selection). And when torque is not being transferred to the rear wheels 42, 44, the propshaft 24 is disconnected or otherwise not actively coupled or being driven. This torque transfer may occur via a gearing system 46 (shown in FIG. 2 and which is described in more detail below). In at least one embodiment, it is desirable to measure the rotational speed and/or temperature of at least one component of the gearing system 46.

FIG. 2 schematically illustrates a few components of an exemplary PTU gearing system 46. For example, the illustrated PTU includes a primary gear 50 coaxially coupled to the drive shaft 32, a transfer shaft 52 carrying a secondary gear 54 that is engaged with the primary gear 50 and a ring and pinion assembly 56 that is coupled to the propshaft 24. More particularly, the assembly 56 comprises a ring gear 58 coupled to the transfer shaft 52 and a pinion gear 60 coupled to the propshaft 24. In the illustrated embodiment, the drive shaft 32 spans through the PTU 20 and engages the front differential assembly 18.

In operation, torque is transmitted through the engine 12 into the transmission 14. Then, torque is transmitted from the transmission 14 into the front differential assembly 18, and then the torque is split between the front drive shafts 30, 32. The torque transmitted to drive shaft 32 rotates the primary gear 50 which in turn rotates and drives the transfer shaft 52 via secondary gear 54 (e.g., at a different angular speed). The driven transfer shaft 52 drives the ring gear 58, which in turn, drives the pinion gear 60—causing the propshaft 24 to rotate, thereby transferring power to the rear differential assembly 26 (shown in FIG. 1).

Returning to FIG. 1, the illustrated PTU 20 further includes a fluid reservoir 70 (e.g., a sump or pan). And in at least one implementation, it is desirable to measure the temperature of the PTU reservoir 70 or the fluid therein—e.g., in addition to measuring a rotational speed associated with the gearing system 46.

FIG. 1 also illustrates a sensing system 72 capable of measuring the rotational speed and temperature of any suitable gears or gearing system—including, but not limited to, the gearing system 46. The sensing system 72 includes an electronic control unit (ECU) 74 coupled to a sensing circuit 76 via a communication link 78. The sensing circuit 76 comprises at least two sensors 80, 82—e.g., a speed sensor and a temperature sensor. In the embodiments described below, the sensing circuit 76 receives sensor data (from sensors 80, 82), configures an electrical signal output that includes both speed and temperature information, and provides that electrical signal output to the ECU 74 via the communication link 78. The ECU 74 is configured to receive the electrical signal and then extract or otherwise determine the speed and temperature data from the signal. Thereafter, among other things, the ECU 74 may use this data to control one or more vehicle systems, provide this data to other vehicle systems, alert a vehicle user based on the data, or any combination thereof. It should be appreciated that while the embodiments herein are described with respect to the PTU gearing system 46 and PTU reservoir 70, these are merely examples to illustrate the operation of the sensing system 72. Other implementations are possible—e.g., sensors 80, 82 may measure other parameters (non-limiting examples include pressure, acceleration, fluid level or volume, etc.), and the sensing circuit 76 may provide an electrical signal output that includes information from any suitable combination of sensors 80, 82 (e.g., information from a temperature sensor and a pressure sensor, or information from an acceleration sensor and a fluid level sensor, etc.). Further, while an assembly for an AWD vehicle is shown and described, it should be appreciated that the sensing system 72 may be used in various components of front-wheel drive only vehicles, rear-wheel drive vehicles, four-wheel drive vehicles, etc.

The ECU 74 may include one or more memory devices 84 coupled to one or more processors 86. Memory 84 includes any non-transitory computer usable or computer readable medium, which may include one or more storage devices or articles. Non-transitory computer usable storage devices 84 may include conventional computer system RAM (random access memory), ROM (read only memory), EPROM (erasable, programmable ROM), EEPROM (electrically erasable, programmable ROM), and magnetic or optical disks or tapes. These of course are merely examples; other non-transitory computer usable storage devices 84 are possible as well. Memory 84 may be used to store instructions used to carry out at least a portion of the method described herein. The instructions may be embodied as software, firmware, or the like and may be executable using the processor(s) 86. In addition, memory 84 may be used to store operational and/or temporal data acquired from the sensing circuit 76 (e.g., speed and/or temperature data).

Processor(s) 86 can be any type of device capable of processing electronic instructions including microprocessors, microcontrollers, electronic control circuits comprising integrated or discrete components, application specific integrated circuits (ASICs), and the like. The processor(s) 86 can be a dedicated processor(s)—used only for ECU 74—or it can be shared with other vehicle systems (not shown). Processor(s) 86 can execute programs, process data and/or instructions, and thereby carry out at least part of the method discussed herein.

The communication link 78 may be any suitable wired or wireless linkage between the ECU 74 and the sensing circuit 76. In at least one embodiment, the link 78 is wired and includes a single electrical path from the sensing circuit 76 to the ECU 74. One example is a two-wire or twisted pair of wires—a signal (or hot) wire and a return (or ground) wire. In another example, only the signal wire is used and the ground wire is omitted; e.g., commonly referred to as a floating ground. These are merely examples; other implementations are also possible.

Turning to FIG. 3, a block diagram illustrates components of the sensing circuit 76. In at least one embodiment, the sensing circuit 76 includes a speed circuit 90 that includes speed sensor 80 and a temperature circuit 92 that includes temperature sensor 82. Other implementations may include circuits or sensors adapted to other functions. In at least some of these implementations, at least one circuit measures a frequency and the other circuit measures an amplitude or magnitude.

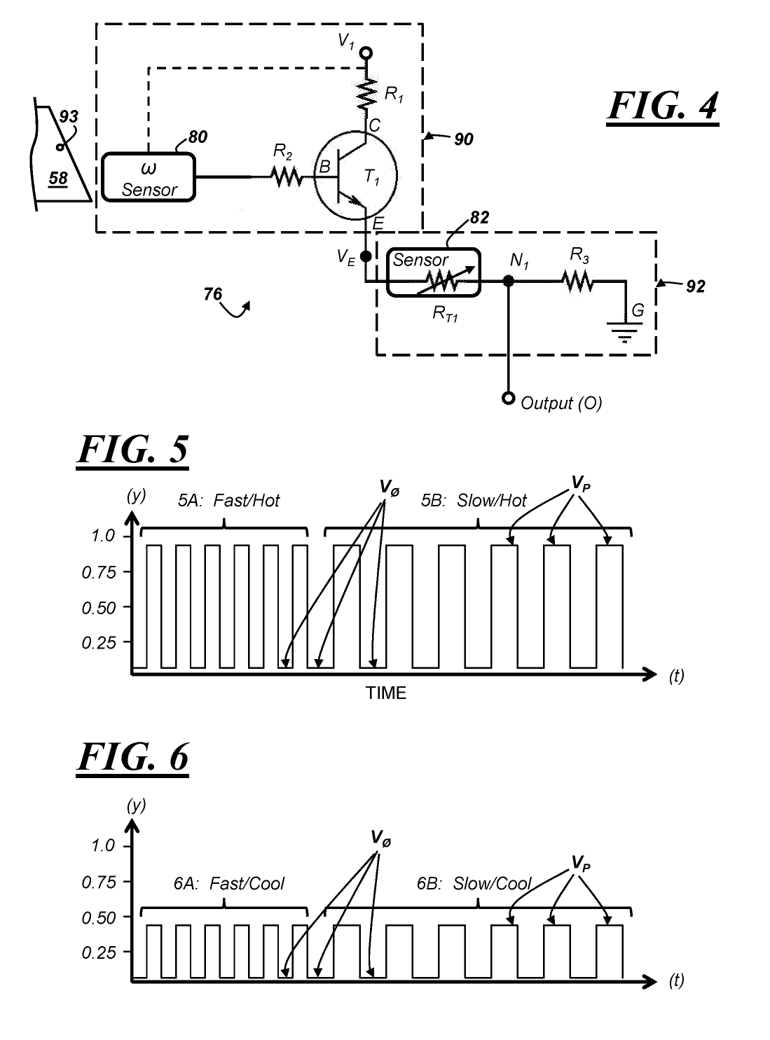

FIG. 4 illustrates embodiments of both speed and temperature circuits 90, 92. As shown, the speed circuit 90 may include a switching element such as transistor T₁, a resistor R₁ coupled between an input voltage V₁ and the transistor's collector (C), speed sensor 80, and a resistor R₂ coupled between sensor 80 and the transistor's base (B) or input. While a NPN transistor is illustrated, other transistors or switching elements may be used instead.

The speed sensor 80 may be any suitable speed sensing circuit or any suitable contact or contactless sensor adapted to sense linear speed, angular speed, reciprocation, or other motion (e.g., in the illustrated embodiment, angular speed of ring gear 58). Non-limiting examples of sensor 80 include a proximity sensor or transducer (e.g., using the Hall Effect), a linear variable differential transformer, an optical encoder, or the like, just to name a few examples. According to one an illustrative embodiment, sensor 80 is a Hall Effect sensor which is responsive to a magnetic field influenced by a ring gear element 93—e.g., which may be located at a periphery of the ring gear 58 (as shown in FIG. 2). In at least one embodiment, element 93 is a permanent magnet or other magnetic component oriented and positioned so that its associated magnetic field is detectable by the Hall Effect sensor 80 as the ring gear 58 rotates. For example, the Hall Effect sensor 80 may provide an electrical output voltage or current based on the magnitude of the magnetic field which changes in response to the rotational position of the gear 58.

As shown in FIG. 4, the speed circuit 90 may be coupled in series with the temperature circuit 92. The temperature circuit 92 includes temperature sensor 82, node N₁, resistor R₃, and ground G. More specifically, the transistor's emitter (E) (or switching element output) may be coupled in series with the temperature sensor 82 and node N₁. Resistor R₃ may be coupled between node N₁ and ground G.

Temperature sensor 82 may be any suitable device or circuit for determining a thermal change in or around a vehicle component—e.g., such as the temperature change of the reservoir 70 (or the fluid therein). In at least one embodiment, temperature sensor 82 is a thermistor (e.g., having resistance R_{T1}). In one implementation, the thermistor 82 is configured so that as the temperature of the thermistor rises, the resistance decreases and the corresponding voltage drop across the thermistor 82 decreases. Other non-limiting examples of temperature sensors 82 include a resistance thermometer, a bandgap temperature sensor, and the like, just to name a couple examples.

In operation of sensing circuit 76, a predetermined voltage is provided at V₁ so that transistor T₁ is powered (e.g., when the vehicle is powered). Similarly, voltage V₁ (or other electrical power) may be provided to Hall Effect sensor 80. When the ring gear 58 rotates, speed sensor 80 may detect a proximity of the element 93 carried by the ring gear 58. For example, the Hall Effect sensor 80 may detect the magnetic field of the permanent magnetic element 93 when rotation of the ring gear 58 places the element 93 in relative proximity with the sensor 80. Each time the Hall Effect sensor 80 detects the element 93, the sensor 80 may provide a change in electrical output (e.g., electrical current). And when the Hall Effect sensor 80 no longer detects the element 93, the sensor 80 may provide little-to-no electrical output (e.g., electrical current).

The alternating ON and OFF of the electrical current may switch the transistor T₁ ON and OFF, respectively, at the base B. Thus, current may flow through the transistor's emitter E only during intervals when the transistor T₁ is actuated ON. The switching pattern of the transistor T₁ is embodied as a square wave—the quantity of pulses per second (the frequency) representing the angular speed of ring gear 58. Exemplary square waves are illustrated in FIGS. 5 and 6 and will be discussed more below—the illustrated peaks V_{P} and valleys V_{Ø} of the square waves correspond to when the transistor T₁ is ON and OFF, respectively.

In FIG. 4, each time the transistor T₁ is actuated ON, current flows through the temperature circuit 92. And the magnitude of the voltage at node N₁ is indicative of the temperature of sensor 82. For example, it should be appreciated that sensor 82 (thermistor R_{T1}), resistor R₃, node N₁, and ground G are arranged as a voltage divider. Therefore, the magnitude of the voltage at node N₁—when the transistor T₁ is actuated ON—equals (R₃/(R₃+R_{T1}))*V_{E} (the voltage at the emitter E), where the value of V_{E} may be determined based on the value of V₁ and the electrical properties of the speed sensor 80 and transistor T₁. Thus, the transmitted analog signal at output (O) to the ECU 74 includes both speed and temperature information.

Therefore, in this embodiment, the processor(s) 86 may be configured to determine the frequency of the ring gear 58 based on the frequency or switching of the transistor T_{R} i.e., based on the peaks V_{P} and valleys V_{Ø} of the output signal. Further, the processor(s) 86 may be configured to extract from the electrical signal the magnitude of the voltage at node N₁ when the transistor T₁ is ON (e.g., at V_{P}). This magnitude may be compared to a look-up table or similar data stored in memory 84 to determine an associated temperature value at the pan 70. In other embodiments, the processor(s) 86 may be configured to determine an average voltage of the square wave. Based on the determined average value, the processor(s) 86 may determine the temperature value at the pan 70. It should be appreciated that the ECU 74 may monitor the electrical, analog signal output (O) continuously, periodically, randomly, or intermittently, or the like.

FIGS. 5-6 show examples of electrical signals received at the ECU 74 via output (O) and link 78. The independent y-axes plot a normalized temperature amplitude (e.g., between 0-100%), and the dependent t-axes represent time. In each of the figures, the electrical signal includes a square wave having pulses which vary in frequency, where a higher square wave frequency (pulses per unit time) indicates a higher measured frequency at sensor 80 (e.g., a higher angular or rotational speed of ring gear 58). In FIGS. 5 and 6, the magnitude or amplitude of each of the square waves is constant; however, the amplitude of the square wave shown in FIG. 5 is greater than the amplitude of the square wave shown in FIG. 6. And the higher amplitude indicates a higher temperature at sensor 82.

Thus, in FIG. 5, time duration 5A indicates a relatively higher angular speed of ring gear 58 while the thermistor 82 is relatively hot. Time duration 5B indicates a relatively slower angular speed of ring gear 58 while the thermistor 82 remains relatively hot.

And with respect to FIG. 6, time duration 6A indicates a relatively higher angular speed of ring gear 58 while the thermistor 82 is relatively cool. Time duration 6B indicates a relatively slower angular speed of ring gear 58 while the thermistor 82 remains relatively cool (e.g., the same temperature as in duration 6A).

Collectively, FIGS. 5 and 6 illustrate that frequency or speed data and temperature data from two different sensors can be superimposed or combined into a composite electrical signal output (O). As used herein, superimposing electrical signal data from at least two sensors excludes serial combination (e.g., it excludes sending frequency data first and then afterwards separately sending temperature data—or vice-versa). As shown in FIGS. 5-6, the frequency and temperature data can be transmitted simultaneously and a single discrete transmission or communication wire may be used between the ECU 74 and sensing circuit 76. For example, circuit 76 may provide data from two sensors non-serially to ECU 74 without communication from ECU 74 to circuit 76—e.g., circuit 76 may be operable without ECU 74 requesting the frequency data, requesting the temperature data, or requesting both. It should be appreciated that the graphs shown in FIGS. 5-6 do not represent empirical data, but are intended only to illustrate exemplary electrical signals from output (O). Further, it should be appreciated that the illustrated square wave is an ideal signal; in practice, rise and fall times of each pulse are not typically instantaneous.

Other implementations of the sensing circuit shown in FIG. 4 also exist. For example, a temperature circuit instead could be located between the speed sensor and the transistor T₁—such that the temperature may be determined regardless of whether the ring gear 58 is rotating. Or for example, the sensing circuit could include two temperature circuits. For example, a first temperature circuit could be coupled between sensor 80 and the transistor base B, and a second temperature circuit could be coupled to the transistor emitter E (as it is shown in FIG. 4). In these implementations, two electrical outputs may be required (e.g., two voltage dividers).

In yet another implementation of the temperature sensor 82 and the speed sensor 80, the voltage magnitude at node N₁ could be used at ECU 74 for calibration purposes. For example, at the ECU 74, if the electrical characteristics of speed sensor 80 drift or vary across an environmental temperature range of the PTU 20, then the processor 86 may use the voltage magnitude at node N₁ to correct or negate temperature-induced error or drift of sensor 80. Again, ECU memory 84 could store look-up data that corresponds to temperature correction values for sensor 80, and processor(s) 86 may be configured to perform such correction calculations using such data.

Now turning to FIG. 7, another embodiment of a sensing circuit is illustrated (e.g., circuit 76′). Here, the sensing circuit 76′ includes a speed circuit 90′, a temperature circuit 92′, and an output or superposition circuit 94. Here, the electrical outputs of the speed and temperature circuits 90′, 92′ may be an input to the superposition circuit 94, as described below.

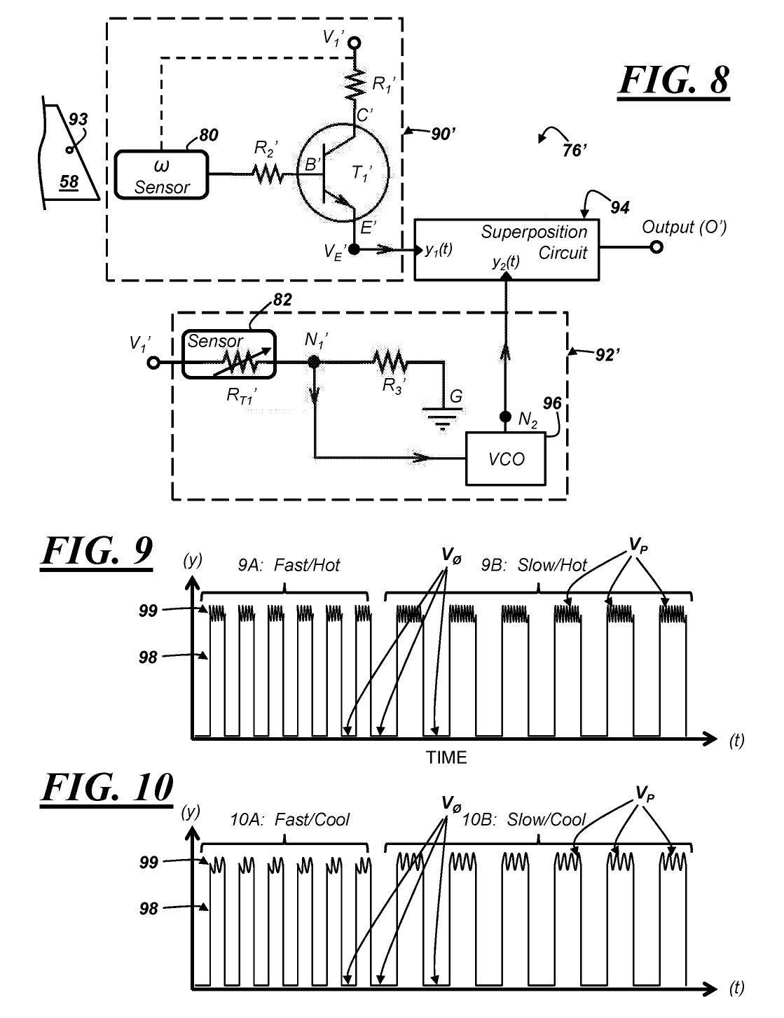

FIG. 8 illustrates a circuit diagram of sensing circuit 76′—here, like numerals represent similar elements or elements having similar functions to those shown in FIG. 4. Speed circuit 90′ is arranged similarly to that shown in FIG. 4; its arrangement and operation will not be re-described here. However, the arrangement of circuit 90′ provides the voltage V_{E}′ (at the switching element output) as a first input y₁(t) to superposition circuit 94.

The temperature circuit 92′ includes a voltage divider arrangement similar to that of circuit 92 (see FIG. 4), but also includes a voltage-controlled oscillator (VCO) 96. Except for two differences, the voltage divider of circuit 92′ may be identical to the voltage divider of circuit 92. First, the input voltage of the voltage divider may be voltage V₁′ or any other suitable voltage when the vehicle is powered (e.g., instead of voltage V_{E}, as it is in circuit 92). Second, node N₁′ is a voltage input to VCO 96 (e.g., instead of the electrical signal output (O), as it is in circuit 92).

VCO 96 may be configured to provide a predetermined frequency based on the input voltage at node N₁′. For example, in at least one embodiment, when the temperature of sensor 82 increases, the voltage at node N₁′ increases. And when the voltage at node N₁′ increases—i.e., when the input voltage to VCO 96 increases—the frequency of the electrical output of VCO 96 (at node N₂) may increase correspondingly. The relationship between the voltage input and the frequency output of VCO 96 may vary, depending on the electrical characteristics of VCO 96. The relationship may be linear, or more commonly, exponential. As shown in FIG. 8, the output of the VCO 96 may be a second input y₂(t) to the superposition circuit 94.

The superposition circuit 94 may combine the frequencies received from the speed and temperature circuits 90′, 92′ into a single electrical signal in any suitable manner. In at least one embodiment, the circuit 94 sums the two frequencies algebraically. For example, the first input may be represented as y₁(t)=A₁*cos(ω₁*t), where A₁ is the amplitude of the signal and ω₁ is the angular frequency. And for example, the second input at node N₂ may be represented as y₂(t)=A₂*cos(ω₂*t), where A₂ is the amplitude of the signal and ω₂ is the angular frequency thereof. Then, the resulting composite wave at output (O′) may be expressed as: A₁*cos(ω₂*t)+A₂*cos(ω₂*t).

FIGS. 9 and 10 illustrate exemplary analog waveforms received at the ECU 74 via output (O′) and link 78—e.g., again, this data is not empirical but instead intended to merely provide examples of electrical signal outputs (O′) of sensing circuit 76′. FIG. 9 illustrates a primary waveform 98 and a secondary or ripple waveform 99 at the peaks V_{P} of the pulses of the primary waveform 98. The primary waveform 98 having a voltage ripple at its peaks V_{P} is one example of a superimposed electrical output of the superposition circuit 94. And in at least one embodiment, the primary waveform 98 may be representative of the angular speed of the ring gear 58 (measured using sensor 80), and the ripple waveform 99 may be representative of the temperature (measured at sensor 82). This superimposed output enables the angular frequency data (extractable from waveform 98 by ECU 74) to be provided with or at the same time as the temperature data (extractable from waveform 99 at ECU 74). In FIG. 9, the angular speed of ring gear 58 during time duration 9A is relatively faster (or higher) than during time duration 9B, as indicated by the change in frequency of the primary waveform 98. In FIG. 9, the frequency of the ripple waveform 99 is generally constant during both durations 9A and 9B indicating a generally constant temperature at sensor 82. As will be apparent from the discussion below, in at least one embodiment, a higher frequency ripple waveform 99 can be indicative of a relatively higher temperature, whereas a lower frequency ripple waveform 99 can be indicative of a relatively lower temperature at sensor 82.

FIG. 10 illustrates another example of a superimposed electrical output of the superposition circuit 94—again, illustrating primary and ripple waveforms 98, 99. In FIG. 10, the angular frequency of ring gear 58 during time duration 10A is relatively faster (or higher) than during time duration 10B, as indicated by the change in frequency of the primary waveform 98. Again, the frequency of the ripple waveform 99 is generally constant during durations 10A and 10B indicating a generally constant temperature at sensor 82. A comparison of FIGS. 9 and 10 reveal that the frequency of the ripple waveform 99 in FIG. 9 is higher than the frequency of the ripple waveform 99 in FIG. 10; in at least one embodiment, this indicates that the temperature at sensor 82 was measured to be higher (in FIG. 9, as opposed to FIG. 10). For example, the lower-frequency ripple waveform (in FIG. 10) (lower temperature at sensor 82) may be attributable to higher resistance at sensor 82 (e.g., thermistor R_{T1}), which results in a lower voltage at node N₁′, which results in a lower voltage input to VCO 96, and which results in a lower frequency output at node N₂. And as explained above, a lower frequency output at node N₂ can result in a smaller or lower frequency ripple at the output (O′) when the y₁(t) and y₂(t) are superimposed.

FIGS. 9 and 10 illustrate another embodiment within which frequency and temperature data from two different sensors can be superimposed or combined into a composite electrical signal output (O′). The circuit 76′ also enables frequency and temperature data to be transmitted simultaneously over a single discrete transmission or communication wire between the ECU 74 and sensing circuit 76′.

The embodiments shown in FIGS. 4 and 8—as well as other like implementations—have been discussed with respect to the PTU 20. It should be appreciated that other components may be measured similarly, including other gear systems or other driveline components. For example, rear-wheel drive vehicles may not have a PTU 20, but instead may have a rear drive module (RDM) (not shown)—e.g., to transfer power from the engine (e.g., in the front of the vehicle) to the rear differential assembly. In such vehicles, the rotational frequency of one or more gears within the RDM could be similarly measured. Other non-limiting examples include a rotating component on a vehicle engine or transmission, a transfer case (e.g., for a 4×4 vehicle), and an electric drive axle.

Other embodiments also exist using sensors which measure any suitable combination of physical properties or characteristics of vehicle devices. Non-limiting examples of physical properties or characteristics include temperature, linear speed, angular speed, acceleration, flow rate, pressure, etc. In other embodiments, at least two properties may be sensed by two different or separate sensors (or measuring circuits). In these embodiments, a sensing circuit may combine or superimpose the electrical signal data (e.g., DC data, AC data, or both) received from sensors into a single composite electrical signal output which may be provided to the ECU 74, any other suitable vehicle system or module, or both.

Thus, there has been described a sensing system for a vehicle which includes a sensing circuit having two sensors or transducers. The sensing circuit is configured to superimpose data sensed and received by the sensors into a single electrical signal which may have frequency and/or magnitude characteristics representing at least two sensed data parameters. The electrical signal then may be transmitted to another vehicle device—e.g., which may be located elsewhere in the vehicle. In some implementations, the sensing system can include an electronic control unit which is configured to determine or extract the original sensed data parameters which make up the now-superimposed electrical signal—e.g., the signal data of the first sensor and the signal data of the second sensor.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A sensing system for a vehicle, comprising:
an electrical sensing circuit that comprises a first sensor and a second sensor, wherein the sensing circuit is configured to receive data from the first and second sensors and provide a composite signal as an output, where the composite signal includes data representative of data from both sensors.

2. The sensing system of claim 1, wherein the sensing circuit is adapted to provide the data received from the first and second sensors simultaneously in the composite signal.

3. The sensing system of claim 1, wherein the first sensor is adapted to provide speed or frequency data, and the second sensor is adapted to provide temperature data, wherein the composite signal comprises a waveform having a frequency and an amplitude, wherein the waveform frequency represents one of the speed or frequency data or the temperature data, and wherein the amplitude of the waveform represents the other one of the frequency or speed data or the temperature data.

4. The sensing system of claim 1, wherein the electrical sensing circuit further comprises a speed circuit that includes the first sensor and a temperature circuit that includes the second sensor, wherein the speed and temperature circuits are arranged in series with one another.

5. The sensing system of claim 4, wherein the temperature circuit is configured to provide the composite signal as the output.

6. The sensing system of claim 1, wherein the first sensor is adapted to receive frequency data, wherein the second sensor is adapted to receive temperature data, wherein the composite signal comprises a primary waveform and a secondary waveform, wherein the primary waveform represents one of the frequency or temperature data, wherein the secondary waveform represents the other one of the frequency or temperature data.

7. The sensing system of claim 1, wherein the electrical sensing circuit further comprises: a speed circuit that includes the first sensor, a temperature circuit that includes the second sensor, and an output circuit, wherein the speed and temperature circuits each are arranged to provide an input to the output circuit.

8. The sensing system of claim 7, wherein the output circuit is configured to algebraically sum the inputs from the speed and temperature circuits, wherein the output circuit is configured to provide the composite signal.

9. The sensing system of claim 1, further comprising one of a power transfer unit (PTU) or a rear drive module (RDM), wherein the first sensor is adapted to sense an angular frequency of a PTU or RDM component and the second sensor is adapted to sense a temperature of at least a portion of the PTU or RDM or fluid carried thereby.

10. The sensing system of claim 1, further comprising a switching element, wherein the first sensor is coupled to an input of the switching element.

11. The sensing system of claim 10, wherein the second sensor is coupled to an output of the switching element.

12. The sensing system of claim 10, further comprising a voltage-controlled oscillator (VCO), wherein the second sensor is coupled to an input of the VCO, wherein an output of the switching element and an output of the VCO are coupled to a superposition circuit, wherein the superposition circuit is adapted to generate the composite signal based on the inputs from the switching element and VCO.

13. The sensing system of claim 1, wherein the first sensor is Hall Effect sensor, and the second sensor is a thermistor.

14. A sensing system for a vehicle, comprising:
an electrical sensing circuit, comprising:
a speed circuit that includes a speed sensor;
a temperature circuit that includes a temperature sensor,
wherein the sensing circuit is configured to provide a composite signal as an output by superimposing data determined by the speed circuit and data determined by the temperature circuit.

15. The sensing system of claim 14, wherein the speed and temperature circuits are arranged in series with one another, and the temperature circuit is configured to provide the composite signal.

16. The sensing system of claim 14, wherein the speed circuit is adapted to receive frequency data using the speed sensor and the temperature circuit is adapted to receive temperature data using the temperature sensor, wherein the composite signal comprises a waveform that includes a frequency, an amplitude, or both which are representative of the frequency and temperature data.

17. The sensing system of claim 14, wherein the sensing circuit further comprises: an output circuit, the speed and temperature circuits each are arranged to provide an input to the output circuit, the superposition circuit being configured to superimpose the inputs and provide the composite signal as the output.

18. The sensing system of claim 17, wherein the superposition circuit is configured to algebraically sum the inputs from the speed and temperature circuits.

19. The sensing system of claim 14, wherein the speed circuit further comprises a switching element, wherein the speed sensor is coupled to an input of the switching element and the temperature sensor is coupled to an output of the switching element.

20. The sensing system of claim 14, wherein the sensing circuit further comprises a voltage-controlled oscillator (VCO) and a switching element coupled to the speed sensor at an input thereof, wherein the temperature sensor is coupled to an input of the VCO, wherein an output of the switching element and an output of the VCO are coupled to a superposition circuit which provides the composite signal based on the inputs from the switching element and VCO.
